(19) United States
(12) Patent Application Publication
(10) Pub. No.: US 2010/0157088 A1
(43) Pub. Date: Jun. 24, 2010

(54) AUTHENTICATION APPARATUS AND AUTHENTICATION METHOD

(75) Inventor: Yuuji IRIMOTO, Fussa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/644,870

(22) Filed: Dec. 22, 2009

(30) Foreign Application Priority Data
Dec. 22, 2008 (JP) 2008-326223

(51) Int. Cl. H04N 5/228; G06K 9/00

(52) U.S. Cl. 348/222.1; 382/118; 348/E05.031

(57) ABSTRACT

According to one embodiment, an authentication method includes performing a verification process includes extracting a face region from an image input from a camera photographing a person, reading first facial characteristic data from the extracted face region, and reading second facial characteristic data associated with personal identification data representing the specific person corresponding to the detected first facial characteristic data, acquiring hand-shape transition pattern data showing transition of a hand shape and associated with the personal identification data associated with the second facial characteristic data, extracting a hand region from the image input from the camera, detecting a transition of a hand shape from the extracted hand region, and determining whether the hand-shape transition pattern data represents the detected transition of the hand shape.

### CROSS-REFERENCE TO RELATED APPLICATIONS

This application is based upon and claims the benefit of priority from Japanese Patent Application No. 2008-326223, filed Dec. 22, 2008, the entire contents of which are incorporated herein by reference.

### BACKGROUND

1. Field

One embodiment of the invention relates to an authentication apparatus and an authentication method, both designed to perform an authentication process by using the shapes of a face and hand photographed with a camera.

2. Description of the Related Art

A technique of authenticating persons by using the face images that a camera has acquired by photographing the persons has been developed. Most conventional face comparison techniques first calculate the similarity the photographed face image of a person has with his or her recorded face image and then identify the person if the similarity exceeds a threshold value. These techniques will take a wrong person for the person if the similarity calculated exceeds as the threshold value.

Jpn. Pat. Appln. KOKAI No. 2008-71366 discloses a technique of authenticating a person on the basis of the identification data input at an input device even, if the face image is similar to any one of the face patterns stored in a face comparison dictionary.

The technique disclosed in Jpn. Pat. Appln. KOKAI No. 2008-71366 needs an input device, as well as a camera. At present it is demanded that the number of components be reduced in order to lower the manufacturing cost of the authentication apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of an authentication apparatus according to an embodiment of the present invention;

FIG. 2 is a block diagram showing the configuration of an application program for use in the embodiment of the invention;

FIG. 3 is a diagram explaining the sequence of the face recognition process according to the embodiment of the invention;

FIG. 4 is a flowchart showing the sequence of a face comparison process according to the embodiment of the invention;

FIG. 5 is a diagram showing a disc-shaped separation filter according to the embodiment of the invention;

FIG. 6 is a diagram illustrating the concept of a constrained mutual subspace method according to the embodiment of this invention; and

FIG. 7 is a flowchart showing the sequence of a comparison process according to the embodiment of the invention.

### DETAILED DESCRIPTION

Various embodiments according to the invention will be described hereinafter with reference to the accompanying drawings. In general, according to one embodiment of the invention, an authentication apparatus includes a camera, a first storage device configured to store first facial characteristic data representing a characteristic of a face of persons and associated with personal identification data representing the persons, a verification module configured to perform a verification process comprising extracting a face region of a person from an image input from the camera, detecting second facial characteristic data from the extracted face region, and reading the first facial characteristic data corresponding to the detected second facial characteristic data from the first storage device, a second storage device configured to store hand-shape transition pattern data associated with the personal identification data and representing transition of change in a hand shape, an acquisition module configured to read the hand-shape transition pattern data, from the second storage device, associated with the personal identification data associated with the first facial characteristic data read by the verification module, a detection module configured to extract a hand region from the image input from the camera and to detect a transition of the hand shape from the extracted hand region, and an authentication module configured to determine whether the hand-shape transition pattern data read by the acquisition module represents the transition of the hand shape detected by the detection module, to determine that authentication of the person succeeds when it is determined that the hand-shape transition pattern data represents the transition of the hand shape, and to determine that authentication of the person fails when it is determined that the hand-shape transition pattern data does not represent the transition of the hand shape.

An embodiment of the present invention will be described with reference to the accompanying drawings.

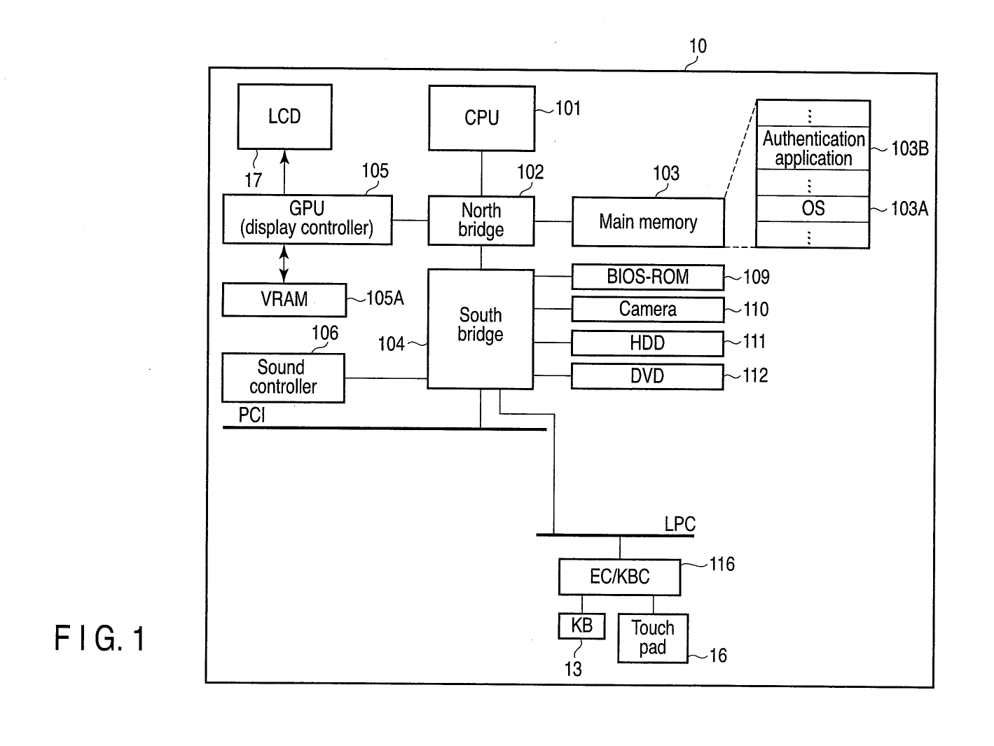

The configuration of an authentication apparatus according to the embodiment of the invention will be described with reference to FIG. 1. The authentication apparatus is implemented in the form of a battery-powered notebook personal computer 10.

FIG. 1 is a block diagram showing the system configuration of the authentication apparatus according to the embodiment.

As shown in FIG. 1, the computer 10 comprises a CPU 101, a north bridge 102, a main memory 103, a south bridge 104, a graphics processing unit (GPU) 105, a video memory (VRAM) 105A, a sound controller 106, a BIOS-ROM 109, a hard disk drive (HDD) 111, a DVD drive 112, and an embedded controller/keyboard controller (CE/KBC) 116.

The CPU 101 is a processor that controls the other components of the host (i.e., computer 10). The CPU 101 executes various application programs that have been loaded from the hard disk drive (HDD) 111 to the main memory 103. The application programs are, for example, an operating system (OS) 103A and an authentication application program 103B. Further, the CPU 101 executes the basic input/output system (BIOS), which is stored in the BIOS-ROM 109. The BIOS is a program that has been described to control the hardware.

The north bridge 102 is a bridge device that connects the local bus of the CPU 101 to the south bridge 104. The north bridge 102 incorporates a memory controller that performs the access control of the main memory 103. The north bridge 102 has the function of performing communication with the GPU 105 through a serial bus of the PCI EXPRESS standard.

The GPU 105 is a display controller that controls an LCD 17 used as display monitor of the computer 10. The GPU 105 generates a display signal, which is sent to the LCD 17.

The south bridge 104 controls the various devices provided on a low-pin count (LPC) bus and the various devices provided on a Peripheral Component Interconnect (PCI) bus. The south bridge 104 incorporates an Integrated Drive Electronics (IDE) controller that controls the hard disk drive (HDD) 111 and the DVD drive 112. The south bridge 104 incorporates a USB controller, too, which controls the communication with USB devices. As a USB device, a camera 110 is connected to the UBS controller incorporated in the south bridge 104. Moreover, the south bridge 104 has the function of communicating with the sound controller 106.

The embedded controller/keyboard controller (CE/KBC) 116 is a one-chip microcomputer that is composed of an embedded controller and a keyboard controller. The embedded controller and keyboard controller are integrated together. The embedded controller achieves power management. The embedded controller controls a keyboard 13 and a touch pad 16. The embedded controller/keyboard controller (CE/KBC) 116 has the function of turn on and off the host 10 when the user operates a power button 14. Further, the embedded controller/keyboard controller (CE/KBC) 116 has the function of communicating with a remote controller unit interface 20.

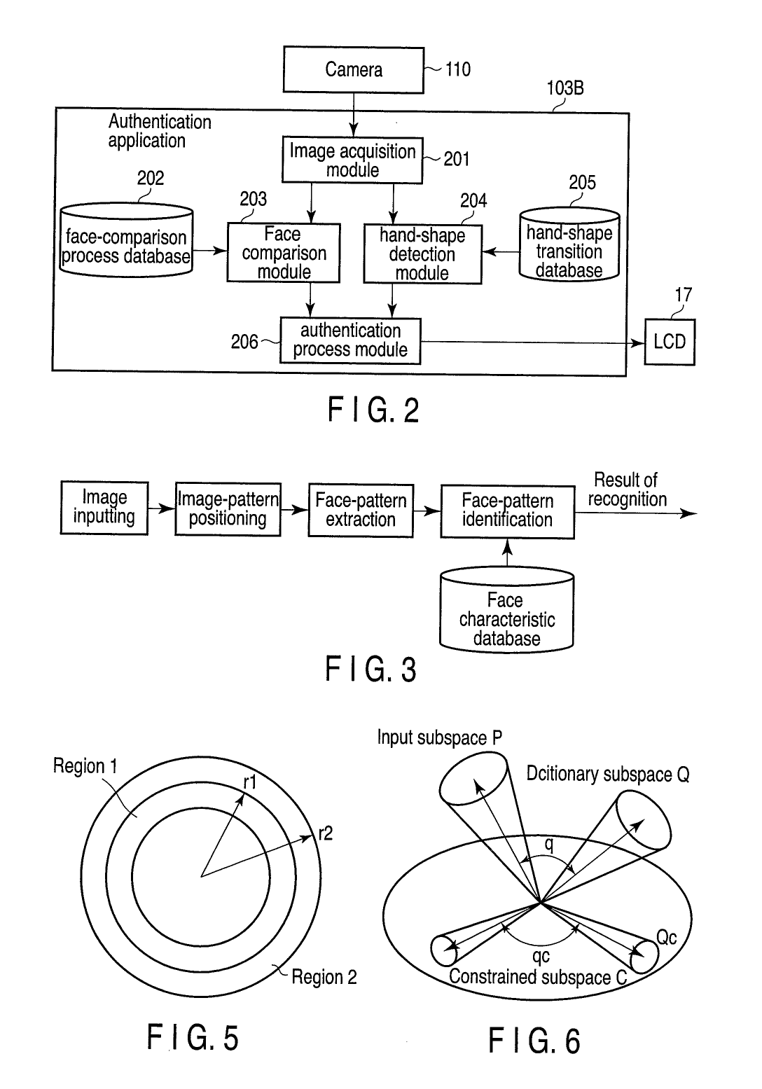

The configuration of the authentication application program 103B will be described with reference to FIG. 2. FIG. 2 is a block diagram that shows the configuration of the authentication application program 103B.

The authentication application program 103B comprises an image acquisition module 201, a face-comparison process database 202, a face comparison module 203, a hand-shape detection module 204, a hand-shape transition database 205, and an authentication process module 206.

The image acquisition module 201 acquires the image data generated by the camera 110 and supplies the image data to the face comparison module 203 and hand-shape detection module 204.

The face-comparison process database 202 stores, for example, the facial characteristic data items contained in the image data the camera 110 has generated. The facial characteristic data is associated with the data (ID numbers) for identifying person. The face-comparison process database 202 is stored in the hard disk drive (HDD) 111 that is used as the first storage device.

The face comparison module 203 performs an authentication process in accordance with the face image represented by the image data input and the facial characteristic data items stored in the face-comparison process database 202. The result of this authentication is output from the module 203 to the authentication process module 206. If the face comparison module 203 successfully authenticates a person, it notifies this facet to the authentication process module 206. At the same time, the module 203 outputs the ID number of the person to the authentication process module 206. If the face comparison module 203 has failed to authenticate the person, it notifies this fact to the authentication process module 206.

The hand-shape detection module 204 detects the shape of the hand shown in the image input. The data representing the shape of the hand, thus detected, is output from the hand-shape detection module 204 to the authentication process module 206.

The hand-shape transition database 205 holds hand-shape transition data items that have ID numbers identical to the respective ID numbers stored in the face-comparison process database 202. Each hand-shape transition data item includes various hand-shape transition patterns, such as a first pattern (the thumb and four fingers bent and put together), a thumb-up pattern (the thumb held up) and a palm pattern (the thumb and four fingers all spread). It is desired that the hand-shape transition patterns pertaining to one ID number be different from those pertaining to any other ID number. It is sufficient, nonetheless, if the hand-shape transition data items about persons the face comparison module 203 may fail to distinguish are different, one from another. The hand-shape transition database 205 is stored in the hard disk drive 111 that is used as the second storage device.

If informed that the face comparison module 203 has successfully recognized the person and if given the ID number from the face comparison module 203, the authentication process module 206 reads the hand-shape transition data item associated with the ID number, from the hand-shape transition database 205. The authentication process module 206 then performs a process, causing the LCD 17 to display a message asking the user to change the shape of his or her hand. The authentication process module 206 compares the hand-shape data input from the hand-shape detection module 204 with the hand-shape data read from the hand-shape transition database 205. That is, the module 206 performs a hand-shape transition comparison process. The module 206 thus determines whether the transition of the hand-shape data input is identical with the hand-shape transition pattern registered in the hand-shape transition data and representing how the hand has changed in shape. If the transition of the hand-shape data input is found identical with the hand-shape transition pattern registered, the authentication process module 206 determines that the user has been authenticated. If the transition of the hand-shape data input is not found identical with the hand-shape transition pattern registered, the authentication process module 206 determines that the user has not been authenticated.

How the face comparison module 203 performs the face comparison will be explained below.

The sequence of the face comparison will be explained with reference to FIG. 3. First, image data is input to the module 203, which performs an image-pattern positioning process. In the image-pattern positioning process, the direction and size of the face are adjusted to predetermined values on the basis of the eye positions facial characteristic points and thereby generates a face pattern. Next, the face comparison module 203 performs a face-pattern extraction process. In the face-pattern extraction process, the characteristics that are hardly influenced by the face, facial expression or illumination and are therefore useful to identify the user. Further, the face comparison module 203 performs a face-pattern identification process. In the face-pattern identification process, the module 203 calculates a difference between the facial characteristics extracted and the facial characteristics previously learned of the user. The face comparison module 203 compares this difference, or similarity, with a threshold value, outputting the result of authentication.

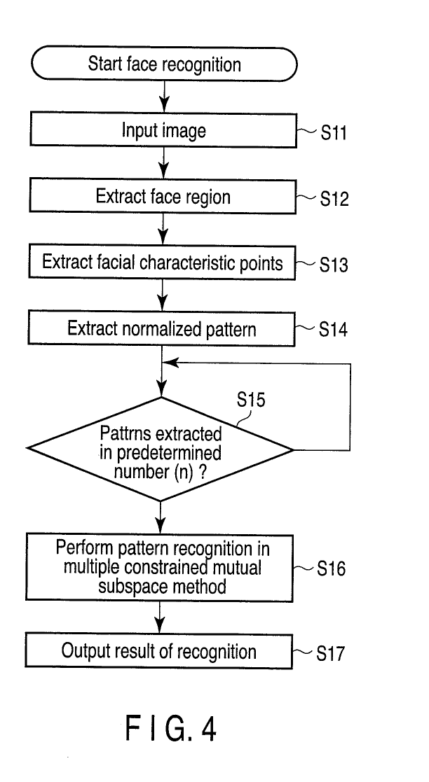

The sequence of the actual face comparison will be explained with reference to the flowchart of FIG. 4.

Assume that the authentication is started. Then, image data is input from the camera 110 (Step S11). The face position in the image is detected. A template representing the face region of the image. The region that has been prepared by the subspace method is matched with the image, thereby calculating the similarity. The entire image is processed, whereby it is determined whether the similarity exceeds the threshold value. Any part of the image, which has similarity exceeding the threshold value, is detected as a face region.

Next, the characteristic points about the eyes and nostrils are extracted from the face region thus detected. The position of the face is thereby determined with high accuracy (Step S12). To extract the characteristic points, a disc-shaped separation filter is used, detecting candidate points. The authentication is then performed by means of pattern comparison. The disc-shaped separation filter finds a statistical difference in luminance between such regions 1 and 2 as shown in FIG. 5. The filter is applied to the face region. The maximum local luminance difference is thereby extracted, and candidate face-characteristic points are acquired. The subspace method is performed, achieving pattern-collection between the candidate face-characteristic points and the eye and nostrils characteristic points that are stored in the face-comparison process database 202. Finally, the positions of the eyes and nostrils are thereby determined (Step S13).

Based on the face characteristic points thus extracted, two-dimensional affine transform is performed. A face pattern normalized in terms of face direction and face size is thereby extracted from the input image (Step S14).

It will be explained how the user is identified by using the face pattern that has been acquired in the face-pattern identification process.

The notable characteristic of this face recognition process resides in that a plurality of face patterns are extracted from a moving picture in time sequence, and that the user is recognized on the basis of the face patterns extracted. That is, a plurality of face patterns are input and used. The similarity between the face patters can therefore be determined. This compensates for the face direction and facial expression that change with time, ultimately accomplishing stable recognition.

As described above, the distribution of the input data must be calculated. To this end, the face-region is repeatedly detected until the face patterns extracted reaches a predetermined number (Step S15). When as many patterns as would provide an input-data distribution, the identification method known as the “constrained mutual subspace method” accomplishes personal identification (Step S16). The result of the personal identification is output (Step S17).

The distribution of face patterns is expressed by using subspaces, in respect with each person. To accomplish personal identification by using subspaces, it suffices to calculate the similarity between the subspaces of each pair and then to determine the subspaces which are more similar than those of any other pair. FIG. 5 illustrates the concept of the constrained mutual subspace method. Assume that an input subspace P and a dictionary subspace Q are available. The input subspace P has been generated from a plurality of patterns input from the camera 110, whereas the dictionary subspace Q is registered in the face-comparison process database 202. Also assume that N canonical angles are defined for the respective N-dimensional subspaces. Therefore, all canonical angles will be 0° if two subspaces are completely identical. The pattern recognition method using the canonical angles is called the “mutual subspace method” (MSM). Any face pattern changes with the illumination conditions under which the user is photographed. Hence, unless the input image and the image registered in the dictionary have not been obtained under the same illumination conditions, the difference in illumination conditions will greatly influence the face pattern even if the canonical angles are determined. Consequently, the facial characteristics of the person may not be accurately detected as is desired. In view of this, a condition that any subspace should include no illumination change components is imposed in the process of obtaining a canonical angle θ. In view of this, the mutual subspace method having this constraining condition is called the “constrained mutual subspace method” (CMSM).

FIG. 6 illustrates the concept of the constrained mutual subspace method. The two subspaces P and Q are first projected into a subspace called the “constrained subspace,” providing two subspaces Pc and Qσ. The angle θd defined by the subspaces Pc and Pσ thus provided is used as similarity. The constrained subspace is calculated from the differences between the many face patterns acquired by photographing the user under different illumination conditions. The difference between any two face patterns acquired under different illumination conditions is therefore considered to have an illumination-change component only. The space orthogonal to this illumination-change component is a constrained subspace. The method of generating the constrained subspace is described in detail in Kazuhiro Fukui et al., Face Recognition Robust to Environmental Changes, Using the Constrained Mutual Subspace Method—Learning of a Constrained Subspace that Suppresses Illumination Fluctuations, the Institute of Electronics, Information and Communication Engineers (IEICE), D-II, Vol. J82-DII, No. 4, pp. 613-620, 1999; Tatsuo Kotaniya et al., Development and Evaluation of a Face Recognition System using the Constrained Mutual Subspace Method, Information Processing Society of Japan, Vol. 45, No. 3, pp. 951-959, 2003; and Kazuhiro Fukui et al., Constrained Mutual Subspace Method Based on a Generalized Differential Subspace, IEICE, D-II, Vol. J87-DII, No. 8, pp. 1622-1631, 2004. In order to achieve high-performance recognition, a multiplex constrained mutual subspace method may be used, in which a plurality of constrained subspaces are used to recognize faces in spite of various fluctuations.

The hand-shape detection process the hand-shape detection module 204 performs will be explained below.

Recognition Based on Image

The hand-shape detection module 204 first detects the image of the user's hand from the image data and then determines the shape and position of the hand. To detect the hand image, a detection window is used. That is, the entire image in the detection window, which has been photographed by the camera 110, scanned. Whether the image in the detection window represents the hand is thereby determined. Since the hand image has a size that changes depending on the user and the distance from the camera, detection windows of various sizes are used to detect the hand image, irrespective of its size of the hand image.

Process of Identifying the Hand

In the process of identifying the user's hand, not only the hand image, but also any other images in the detection window, including the images of objects in the background, are identified based on their luminance patterns. The image of the hand that should be detected is thereby recognized. The hand image differs not only in shape from user to user, but also in luminance pattern that depends on the brightness in the room and the objects existing in the background.

Therefore, the hand-shape detection module 204 uses an identification device that can identify the shape of any user's hand by analyzing any image that exists in the detection window. The identification device holds data representing a number of characteristics of various hand images. Note that each of the characteristics is defined by two rectangular regions, or a positive region and a native region. To identify the shape of the user, the average luminance of the rectangular regions of either type is first calculated. The similarity is then determined in accordance with whether the difference between the average luminance for the rectangular regions of one type and that for the rectangular regions of the other type exceeds the threshold value set for the characteristic. The similarity exceeds an identification threshold value, the hand image will be identified as pertaining to the hand that should be detected.

To design the identification device, images photographed of many persons of different age, sex and race under various illumination conditions are used as sample images. More precisely, of these sample images, those useful for identifying the user are selected. The sample images thus selected are used, correctly identify the user, under whatever conditions the identification is performed.

Process of Tracking the Hand

When the image of the user's hand is detected, the data representing the position and size of the hand is stored and the image in the region is held as template image.

When the next image is input, the region to search for the hand is determined on the basis of the region in which the immediately preceding hand image has been detected. In the region thus determined, an image similar to the template image is searched for. The position of the hand is thereby roughly inferred. More specifically, the window of the same size as the template image is scanned in the search region, and a template-matching process is performed, determining the position where the difference between the image in the window and the template image is minimal in terms of luminance pattern is performed, and ultimately inferring the position of the hand.

Further, the process of identifying the hand is performed on a limited region centering at the hand position, thus determining a final hand region. Furthermore, the template image in the final hand region is updated. The positioned detected in the template-matching process is not correct, due to the change in the angle of the hand changes or in the condition of identifying the hand. Therefore, the region in which to identify the hand is set around the inferred position of hand. The hand is identified as described in “Process of Identifying the Hand,” while changing the position within the region in the detection window. Thus, the hand-shape detection module 204 outputs the data representing the hand shape detected, to the authentication process module 206.

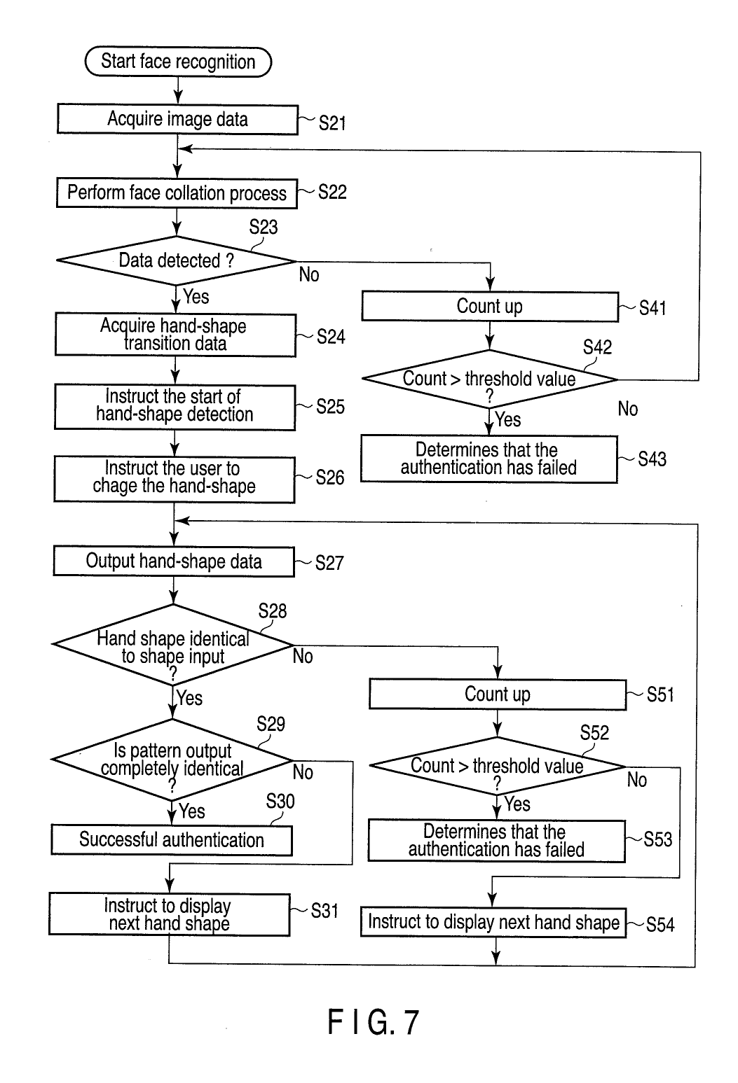

The sequence of the process that the authentication application program 103B performs will be explained below, with reference to the flowchart of FIG. 7.

First, the image acquisition module 201 acquires image data from the camera 110 (block S21). The image acquisition module 201 then transfers the image data to the face comparison module 203 and hand-shape detection module 204.

The face comparison module 203 performs a face comparison process. That is, the module 203 compares the face in the image represented by the image data with the facial characteristic data stored in the face-comparison process database 202, thereby detecting the facial characteristic data item having the highest similarity that exceeds the threshold value. The face comparison module 203 sends a notification to the authentication process module 206, informing the module 206 of the result of the face comparison process.

On receiving the notification, the authentication process module 206 determines whether the facial characteristic data has been detected (block S23). If the facial characteristic data has not been detected (No in block S23), the authentication process module 206 counts the number of times the face comparison has failed (block S41). Then, the authentication process module 206 determines whether the count exceeds a preset value (block S42). If the count exceeds a preset value (Yes in block S42), the authentication process module 206 determines that the authentication has failed (block S43). If the count does not exceed a preset value (No in block S42), the authentication process module 206 causes the face comparison module 203 to perform the comparison process.

In block S23, it may be determined that the facial characteristic data has been detected (that is, Yes in block S23). If this is the case, the authentication process module 206, which is an acquisition means, reads from the hand-shape transition database 205 the hand-shape transition data associated with the ID number that is contained in the notification (block S24). The authentication process module 206 then instructs the hand-shape detection module 204 to start detecting the shape of the hand (block S25). Next, the authentication process module 206 causes the LCD 17 to display the message, which asks the user to change the shape of his or her hand to the initial shape so that the hand-shape transition pattern may be compared (block S26).

If the user's hand changes in shape, the hand-shape detection module 204 generates data representing the shape of the hand. This data is output to the authentication process module 206 (block S27). The authentication process module 206 determines whether the hand shape represented by the data is identical to the hand-shape transition pattern output from the hand-shape detection module 204 (block S28). If the hand shape is identical to the hand-shape transition pattern (Yes in block S28), the authentication process module 206 determines whether the hand-shape transition pattern output from the hand-shape detection module 204 is completely identical to the hand-shape transition pattern contained in the hand-shape transition data (block S29). If the pattern is not identical to the hand-shape transition data (No in block S29), the authentication process module 206 causes the LCD 17 to display the message asking the user to change the shape of his or her hand to the hand shape next to the hand-shape transition pattern (block S31). If the pattern is identical to the hand-shape transition data (Yes in block S29), the authentication process module 206 determines that the authentication has been performed in success (block S30).

In block S28, the hand shape may not be found identical to the hand-shape transition pattern (that is, No in block S28). In this case, the authentication process module 206 counts the number of times the hand-shape transition has failed (block S51). Then, the module 206 determines whether the count exceeds a preset threshold value (block S52). If the count exceeds the threshold value (Yes in block S52), the authentication process module 206 determines that the authentication process has failed (block S54). If the count does not exceed the threshold value (No in block S52), the authentication process module 206 causes the LCD 17 to display the message asking the user to change the shape of his or her hand to the initial hand-shape transition pattern (block S54).

In most face comparison processes of the type described above, the similarity is calculated and compared with a threshold value, thereby to identify the user. Hence, the face image of a person who resembles the user has similarity that exceeds the threshold value, and this person may therefore be identified as the user.

In the authentication process according to this embodiment, the person is not identified as the user, though he or she resembles the user, unless his or her personal data agrees to the registered personal data in the hand-shape transition comparison process. That is, such persons can be distinguished from the user. This easily accomplishes high-security authentication.

The authentication apparatus according to this embodiment has only one input device, i.e., camera 110. In other words, it needs no other input devices. The camera 110 (i.e., sole input device) can serve to perform both the face comparison and the hand-shape transition comparison. Therefore, the user need not operate the keyboard or the like to input his or her identification number.

In the embodiment described above, the notebook-type portable personal computer 10 performs the authentication process. The computer 10 has a keyboard 13 and a touch pad 16. However, the computer 10 need not have the keyboard 13 or the touch pad 16 if it is used to perform the authentication process only.

The authentication process according to this embodiment is implemented by a computer program. If this computer program is installed into an ordinary computer through a computer-readable recording medium, the computer can easily achieve the same advantages as the embodiment described above. Moreover, the computer program can be executed not only in personal computers, but also in electronic apparatuses that incorporate a processor.

The present invention is not limited to the embodiments described above. The components of any embodiment can be modified in various manners in reducing the invention to practice, without departing from the sprit or scope of the invention. Further, the components of any embodiment described above may be combined, if necessary, in various ways to make different inventions. For example, some of the component of any embodiment may not be used. Moreover, the components of different embodiments may be combined in any desired fashion.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An authentication apparatus comprising:
a camera;
a first storage device configured to store reference characteristic data of a first object of a user associated with user identification data;
a verification module configured to verify a user by detecting first characteristic data of a first object region of the first object of an image from the camera, and reading the reference characteristic data corresponding to the detected first characteristic data from the first storage device;
a second storage device configured to store second object-shape transition pattern data associated with the user identification data and indicative of a transition in a shape of a second object;
a transition pattern data reader configured to read the second object-shape transition pattern data from the second storage device, the second object-shape transition pattern data being associated with the read reference characteristic data;
a detection module configured to detect a transition of the second object shape in a second object region of the image from the camera; and
an authentication module configured to determine whether the read second object-shape transition pattern data corresponds with the transition of the second object shape detected by the detection module, and to authenticate the user when it is determined that the second object-shape transition pattern data corresponds with the transition of the second object shape.

2. The apparatus of claim 1, further comprising an instruction module configured to instruct the user to change the second object shape, when the verification module reads the reference characteristic data corresponding to the detected first characteristic data from the first storage device,
wherein the detection module is configured to start detecting the transition of the second object shape after the instruction module instructs the user to change the second object shape.

3. The apparatus of claim 1, further comprising an instructing module configured to instruct the verification module to retry verification of the user when the verification module fails to read the reference characteristic data corresponding to the detected first characteristic data from the first storage device,
wherein the authentication module is configured to determine that authentication of the user failed when the verification module has failed to read the reference characteristic data corresponding to the first characteristic data from the first storage device a predetermined number of times.

4. The apparatus of claim 1, wherein the authentication module is configured to determine the second object-shape transition pattern data read with the transition of the second object shape detected by the detection module when it is determined that the second object-shape transition pattern data does not correspond with the transition of the second object shape, and to determine that the authentication of the used failed when the detected second object-shape transition pattern data has failed to correspond with the transition of the second object shape detected by the detection module a predetermined number of times.

5. The apparatus of claim 1, wherein the verification module is configured to compare the second object-shape transition pattern data with the transition of the second object shape using a constrained mutual subspace method or a multiplex constrained mutual subspace method or.

6. An authentication method comprising:
receiving an image input;
verifying a user comprising reading reference characteristic data from a first region in the image input indicative of the user, and detecting first characteristic data associated with user identification data indicative of the user corresponding to the read reference characteristic data;
reading second object-shape transition pattern data indicative of a transition in a shape of a second object and associated with the first characteristic data;
detecting a transition of a second object shape in a second object region of the image input; and
determining whether the second object-shape transition pattern data corresponds with the detected transition of the second object shape; and
authenticating the user when it is determined that the second object-shape transition pattern data corresponds with the detected transition of the second object shape.

7. The method of claim 6, further comprising:
instructing the user to change the second object shape when the first characteristic data corresponding to the reference characteristic data is detected,
wherein the detecting of the transition of the second object shape is performed after the instructing.

8. The method of claim 6, further comprising:
retrying to verify the user when the first characteristic data corresponding to the reference characteristic data detected has not been detected; and
determining that authentication of the user has failed when the first characteristic data did not correspond to the reference characteristic data a predetermined number of times.

9. The method of claim 6, further comprising:
determining whether the second object-shape transition pattern data corresponds with the detected transition of the second object shape when the second object-shape transition pattern data does not correspond with the detected transition of the second object shape; and
determining that authentication of the user has failed when the second object-shape transition pattern data does not correspond with the transition of the second object shape a predetermined number of times.

10. A program stored in a computer-readable medium configured to be executed by a computer to perform an authentication process using a first object image and a second object image, the program causes the computer to:
read second object-shape transition pattern data indicative of transition of a shape of a second object and associated with the first characteristic data;
detect a transition of a second object shape in a second object region of the second object image; and
determine whether the second object-shape transition pattern data corresponds with the detected transition of the second object shape; and
authenticate the user when it is determined that the second object-shape transition pattern data corresponds with the detected transition of the second object shape.
